(19) United States
(12) Patent Application Publication
(10) Pub. No.: US 2025/0316073 A1
(43) Pub. Date: Oct. 9, 2025

(54) METHOD AND SYSTEM FOR PROVIDING A MACHINE-LEARNING ALGORITHM FOR OBJECT DETECTION

(71) Applicant: dSPACE GmbH, Paderborn (DE)

(72) Inventor: Daniel HASENKLEVER, Guetersloh (DE)

(73) Assignee: dSPACE GmbH, Paderborn (DE)

(21) Appl. No.: 19/241,867

(22) Filed: Jun. 18, 2025

Related U.S. Application Data
(63) Continuation of application No. PCT/EP2023/086115, filed on Dec. 15, 2023.

(30) Foreign Application Priority Data
Dec. 19, 2022 (DE) 10 2022 133 818.5

(51) Int. Cl. G06V 10/82; G06V 20/56

(52) U.S. Cl. CPC G06V 10/82; G06V 20/56

(57) ABSTRACT

A computer-implemented method for providing a machine-learning algorithm for object detection, wherein an input-side section and an output-side section of the second machine-learning algorithm have a predetermined number of layers derived from the trained first machine-learning algorithm. The input-side section of the second machine-learning algorithm has frozen weights. The second machine-learning algorithm has a predetermined number of additional layers inserted between the input-side section and the output-side section. A computer-implemented method for object detection by a machine-learning algorithm, a system for providing a machine-learning algorithm for object detection, and a system for object detection by a machine-learning algorithm are also provided.

This nonprovisional application is a continuation of International Application No. PCT/EP2023/086115, which was filed on Dec. 15, 2023, and which claims priority to German Patent Application No. 10 2022 133 818.5, which was filed in Germany on Dec. 19, 2022, and which are both herein incorporated by reference.

### FIELD OF THE INVENTION

The present invention relates to a computer-implemented method for providing a machine-learning algorithm for object detection. The present invention additionally relates to a computer-implemented method for object detection by a machine-learning algorithm. In addition, the present invention relates to a system for providing a machine-learning algorithm for object detection. The present invention furthermore relates to a system for object detection by a machine-learning algorithm. Moreover, the invention relates to a computer program with program code in order to carry out the method according to the invention.

### DESCRIPTION OF THE BACKGROUND ART

Algorithms for object detection for highly automated driving can be provided with the aid of various training methods.

EP 3446281 A1, which corresponds to US 2019/0130215, discloses a training method for object recognition wherein the training method includes a providing of at least one training image in top view, aligning a training object in the training image along a predetermined direction, annotating at least one training object from the at least one training image using a predefined annotation scheme, extracting at least one feature vector for describing the content of the at least one labeled training object and at least one feature vector for describing at least one background scene, and training a classifier model based on the extracted feature vectors.

Conventionally, a neural network for object detection is therefore trained as though on an ordinary data set that has various individual frames. The trained network generally has satisfactory performance in inference on individual frames.

In the case of sequences, however, errors occur; performance varies on individual time steps. In the case of an object detector, it is conceivable that a bounding box flickers or changes greatly in size from time step to time step, for example.

Accordingly, there is a need to improve existing methods for object detection for highly automated driving such that improved performance of the neural network is made possible for image sequences.

### SUMMARY OF THE INVENTION

It is therefore an object of the invention to provide an improved method for providing a machine-learning algorithm for object detection that makes possible improved performance of the machine-learning algorithm for image sequences. It also an object of the present invention to provide a computer-implemented method for providing a machine-learning algorithm for object detection.

The object is also attained according to the invention by a computer-implemented method for object detection by a machine-learning algorithm.

The object is additionally attained according to the invention by a system for providing a machine-learning algorithm for object detection.

In addition, the object is attained by a system for object detection by a machine-learning algorithm.

The object is furthermore attained according to the invention by a computer program with program code in order to carry out the method according to the invention.

The invention also relates to a computer-implemented method for providing a machine-learning algorithm for object detection.

The method includes a training of a first machine-learning algorithm for object detection using a first training data set of individual images, in particular based on sensor data of a vehicle environment.

In addition, the method includes a training of a second machine-learning algorithm for object detection using a second data set comprising a plurality of time series images.

An input-side section and an output-side section of the second machine-learning algorithm in this case have a predetermined number of layers derived from the trained first machine-learning algorithm, wherein the input-side section of the second machine-learning algorithm has frozen weights, and wherein the second machine-learning algorithm furthermore has a predetermined number of additional layers inserted between the input-side section and the output-side section.

The invention furthermore relates to a computer-implemented method for object detection by a machine-learning algorithm.

The method includes a providing of a first data set comprising a plurality of time series images, in particular based on sensor data of a vehicle environment.

In addition, the method includes an applying of a machine-learning algorithm trained to the data set comprising the plurality of time series images for object detection, as well as an outputting of a second data set representing a result of the object detection, having objects, in particular annotated objects, in the plurality of time series images.

The invention further relates to a system for providing a machine-learning algorithm for object detection.

The system includes a training computing unit that is configured to train a first machine-learning algorithm for object detection using a first training data set of individual images, in particular based on sensor data of a vehicle environment.

The training computing unit can be furthermore configured to train the second machine-learning algorithm for object detection using a second data set comprising a plurality of time series images.

An input-side section and an output-side section of the second machine-learning algorithm can have a predetermined number of layers derived from the trained first machine-learning algorithm, wherein the input-side section of the second machine-learning algorithm has frozen weights, and wherein the second machine-learning algorithm furthermore has a predetermined number of additional layers inserted between the input-side section and the output-side section.

The invention further relates to a system for object detection by a machine-learning algorithm.

The system can include a data receiving device that is configured to receive a first data set comprising a plurality of time series images, in particular based on sensor data of a vehicle environment.

In addition, the system can include a computing device that is configured to apply a machine-learning algorithm trained according to the invention to the data set comprising the plurality of time series images for object detection.

Furthermore, the system can include an output device that is configured to output a second data set representing a result of the object detection, in particular having annotated objects in the plurality of time series images.

The invention further relates to a computer program with program code in order to carry out a method for object detection by a machine-learning algorithm according to the invention when the computer program is executed on a computer.

Machine-learning algorithms can be based on using methods of statistics to train a data processing system such that it can execute a specific task without originally having been explicitly programmed for that purpose. The goal of machine learning in this case is to design algorithms that learn from data and can make predictions. These algorithms create mathematical models with which data can, for example, be classified, and in the present case objects can be detected.

“Performance” can be understood, moreover, as a measure for the quality or capability of the trained machine-learning algorithm with respect to an appropriate performance metric, in the present case with respect to object detection in image sequences.

“Image data” in this case can be understood as data that can be rendered as image or graphics with the aid of a specialized program. The fact that an object is represented in image data furthermore means that the corresponding image data show the object, or rather have a representation of the object.

An idea of the present invention is to slice open the second trained network and insert another neural network, in particular a small neural network.

The small network can be trained on a small data set that includes short sequences. In this case, the parts of the second network that are located upstream of the inserted first network are frozen and are not trained with it. The downstream parts are trained anew with the second network.

The combination of the first network and the second network is now used as a new network for inference on sequential data.

The essential advantages reside in that the training strategy makes it possible to train a base model on large, diverse, non-sequential data sets and to expand and to optimize it for application to sequential data by means of a small module.

According to an example, provision is made that the training of the first machine-learning algorithm includes a providing of a third training data set representing a result of the object detection having annotated objects in the individual images, as well as a training of the first machine-learning algorithm by a first optimization algorithm that calculates an extreme value of a loss function for object detection.

As a result, a trained first machine-learning algorithm can be provided that is based on a first training data set of individual images from sensor data of a vehicle environment.

The training of the second machine-learning algorithm can include a providing of a fourth training data set representing a result of the object detection, in particular having annotated objects in the plurality of time series images, as well as a training of the second machine-learning algorithm by a second optimization algorithm that calculates an extreme value of a loss function for object detection.

As a result, a trained first machine-learning algorithm can be provided that is based on a second training data set of a plurality of time series images from sensor data of a vehicle environment.

The second machine-learning algorithm can receive the plurality of time series images of the second training data set in parallel.

As a result, a parallel processing of the time series images of the second training data set by the second machine-learning algorithm can be ensured.

The plurality of time series images of the second training data set can be propagated in parallel by the input-side section of the second machine-learning algorithm.

As a result, it is advantageously possible to achieve the result that the time series images of the second training data set are initially propagated with the use of the input-side section of the second machine-learning algorithm trained on the basis of individual images.

The plurality of time series images of the second training data set propagated in parallel by the input-side section of the second machine-learning algorithm can be received in parallel by a first of the additional layers inserted between the input-side section and the output-side section.

As a result, a parallel processing of the second training data set can be carried out using the additional layers trained on the basis of the plurality of time series images.

The first and/or a second of the additional layers inserted between the input-side section and the output-side section can combine, and output at the output-side section of the second machine-learning algorithm, the plurality of time series images of the second training data set. As a result, improved detection of the objects contained in the time series images can be made possible in an advantageous manner.

A weighted sum can be formed of the output data of the output-side section of the first machine-learning algorithm and the output data of the output-side section of the second machine-learning algorithm. In this way, optimal coordination of the first machine-learning algorithm with the second machine-learning algorithm can be achieved.

The output data of the output-side section of the second machine-learning algorithm can be weighted more heavily than the output data of the output-side section of the first machine-learning algorithm.

As a result, the component of the second machine-learning algorithm trained on the time series images is weighted more heavily, which leads to improved detection of objects in time series images.

The first machine-learning algorithm and/or the second machine-learning algorithm can be composed of a recurrent neural network. This permits an optimal structure for integration of the first neural network into the second neural network.

The plurality of time series images of the second training data set can be composed of a sequence of four to five individual images over a time period of one to two seconds.

As a result, the most possible training examples or diversity can be covered in an advantageous manner using as small a data quantity as possible.

The features described herein of the computer-implemented method for providing a machine-learning algorithm for object detection are likewise applicable to the system for providing a machine-learning algorithm for object detection and vice versa.

Likewise, the features described herein of the computer-implemented method for object detection by a machine-learning algorithm are applicable to the system for object detection by a machine-learning algorithm and vice versa.

Further scope of applicability of the present invention will become apparent from the detailed description given hereinafter. However, it should be understood that the detailed description and specific examples, while indicating preferred embodiments of the invention, are given by way of illustration only, since various changes, combinations, and modifications within the spirit and scope of the invention will become apparent to those skilled in the art from this detailed description.

### BRIEF DESCRIPTION OF THE DRAWINGS

The present invention will become more fully understood from the detailed description given hereinbelow and the accompanying drawings which are given by way of illustration only, and thus, are not limitive of the present invention, and wherein:

FIG. 1 shows a flowchart of a computer-implemented method for providing a machine-learning algorithm for object detection according to an example of the invention;

FIG. 2 shows a flowchart of a computer-implemented method for object detection by a machine-learning algorithm according to an example of the invention;

FIG. 3 shows a schematic representation of a system for providing a machine-learning algorithm for object detection according to an example of the invention; and

FIG. 4 shows a schematic representation of a system for object detection by a machine-learning algorithm according to an example of the invention.

### DETAILED DESCRIPTION

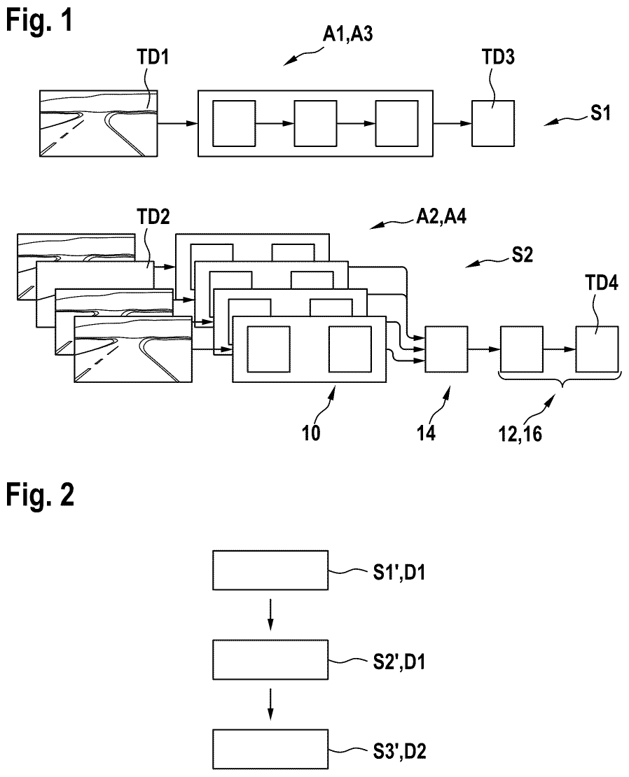

The computer-implemented method for providing a machine-learning algorithm for object detection shown in FIG. 1 includes a training S1 of a first machine-learning algorithm A1 for object detection using a first training data set TD1 of individual images, in particular based on sensor data of a vehicle environment.

In addition, the method includes a training S2 of a second machine-learning algorithm A2 for object detection using a second data set TD2 comprising a plurality of time series images, wherein an input-side section 10 and an output-side section 12 of the second machine-learning algorithm A2 have a predetermined number of layers derived from the trained first machine-learning algorithm A1.

The input-side section 10 of the second machine-learning algorithm A2 has frozen weights in this case. Furthermore, the second machine-learning algorithm A2 has a predetermined number of additional layers 14 inserted between the input-side section 10 and the output-side section 12.

The training of the first machine-learning algorithm A1 additionally includes a providing of a third training data set TD3 representing a result of the object detection having annotated objects in the individual images, as well as a training of the first machine-learning algorithm A1 by a first optimization algorithm A3 that calculates an extreme value of a loss function for object detection.

In addition, the training of the second machine-learning algorithm A2 includes a providing of a fourth training data set TD4 representing a result of the object detection, in particular having annotated objects in the plurality of time series images, as well as a training of the second machine-learning algorithm A2 by a second optimization algorithm A4 that calculates an extreme value of a loss function for object detection.

The second machine-learning algorithm A2 receives the plurality of time series images of the second training data set TD2 in parallel, which is to say essentially simultaneously. Alternatively, the plurality of time series images can, for example, be received sequentially, temporarily stored, and then processed in parallel by the second machine-learning algorithm A2.

The plurality of time series images of the second training data set TD2 are furthermore propagated in parallel by the input-side section 10 of the second machine-learning algorithm A2. The plurality of time series images of the second training data set TD2 propagated in parallel by the input-side section 10 of the second machine-learning algorithm A2 are received in parallel in this case by a first of the additional layers 14 inserted between the input-side section 10 and the output-side section 12.

The first and/or a second of the additional layers 14 inserted between the input-side section 10 and the output-side section 12 combines the plurality of time series images of the second training data set TD2 and outputs them at the output-side section 12 of the second machine-learning algorithm A2.

Furthermore, a weighted sum is formed of the output data 16 of the output-side section 12 of the first machine-learning algorithm A1 and the output data 16 of the output-side section 12 of the second machine-learning algorithm A2.

The output data 16 of the output-side section 12 of the second machine-learning algorithm A2 are weighted more heavily here than the output data 16 of the output-side section 12 of the first machine-learning algorithm A1.

The first machine-learning algorithm A1 and/or the second machine-learning algorithm A2 are composed of a recurrent neural network. Furthermore, the plurality of time series images of the second training data set TD2 is composed of a sequence of four to five individual images over a time period of one to two seconds.

FIG. 2 shows a flowchart of a computer-implemented method for object detection by a machine-learning algorithm according to an example of the invention.

The method includes a providing S1′ of a first data set D1 comprising a plurality of time series images, in particular based on sensor data of a vehicle environment.

In addition, the method includes an applying S2′ of a machine-learning algorithm, trained according to the invention, to the first data set D1 comprising the plurality of time series images for object detection.

The method additionally includes an outputting S3′ of a second data set D2 representing a result of the object detection, having objects, in particular annotated objects, in the plurality of time series images.

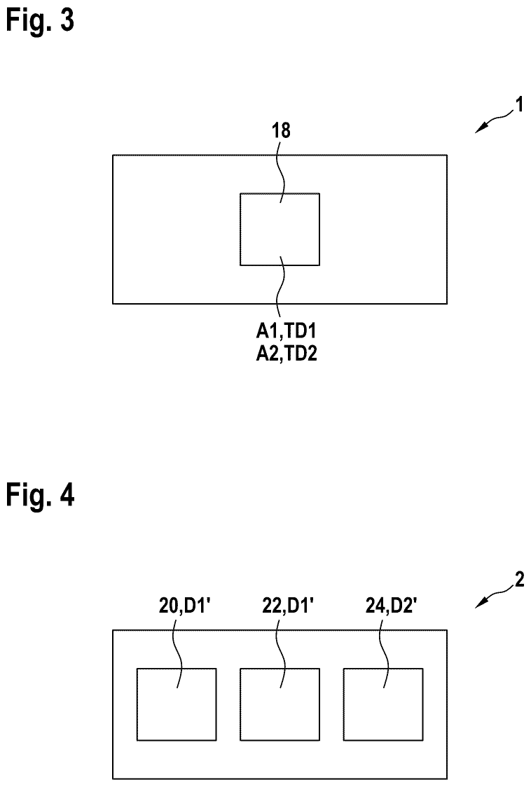

FIG. 3 shows a schematic representation of a system for providing a machine-learning algorithm for object detection according to an example of the invention.

The system includes a training computing unit 18 that is configured to train a first machine-learning algorithm A1 for object detection using a first training data set TD1 of individual images, in particular based on sensor data of a vehicle environment.

The training computing unit 18 is furthermore configured to train the second machine-learning algorithm A2 for object detection using a second data set TD2 comprising a plurality of time series images.

An input-side section 10 and an output-side section 12 of the second machine-learning algorithm A2 have a predetermined number of layers derived from the trained first machine-learning algorithm A1.

The input-side section 10 of the second machine-learning algorithm A2 furthermore has frozen weights. In addition, the second machine-learning algorithm A2 furthermore has a predetermined number of additional layers 14 inserted between the input-side section 10 and the output-side section 12.

FIG. 4 shows a schematic representation of a system for object detection by a machine-learning algorithm according to an example of the invention.

The system includes a data receiving device 20 that is configured to receive a first data set D1′ comprising a plurality of time series images, in particular based on sensor data of a vehicle environment.

Furthermore, the system includes a computing device 22 that is configured to apply a machine-learning algorithm, trained according to the invention, to the first data set D1′ comprising the plurality of time series images for object detection.

The system includes, in addition, an output device 24 that is configured to output a second data set D2′ representing a result of the object detection, in particular having annotated objects in the plurality of time series images.

Even though the examples have been illustrated and described herein, it is evident to the person skilled in the art that a multitude of alternative and/or equivalent implementations exist. It should be noted that the exemplary embodiment or embodiments are merely examples and do not serve to limit the scope, the applicability, or the configuration in any way.

The abovementioned summary and detailed description provides the person skilled in the art with convenient guidance for implementing examples, wherein it is evident that various modifications may be made in the functional scope and the arrangement of the elements without departing from the scope of the attached claims and their legal equivalents.

In general, the intent of this application is to cover modifications or adaptations or variations of the examples provided herein. For example, a sequence of the method steps can be altered. Moreover, the method can be carried out sequentially or in parallel, at least in sections.

The invention being thus described, it will be obvious that the same may be varied in many ways. Such variations are not to be regarded as a departure from the spirit and scope of the invention, and all such modifications as would be obvious to one skilled in the art are to be included within the scope of the following claims.

What is claimed is:

1. A computer-implemented method for providing a machine-learning algorithm for object detection, the method comprising:
training a first machine-learning algorithm for object detection using a first training data set of individual images based on sensor data of a vehicle environment; and
training a second machine-learning algorithm for object detection using a second data set comprising a plurality of time series images,
wherein an input-side section and an output-side section of the second machine-learning algorithm have a predetermined number of layers derived from the trained first machine-learning algorithm,
wherein the input-side section of the second machine-learning algorithm has frozen weights, and
wherein the second machine-learning algorithm furthermore has a predetermined number of additional layers inserted between the input-side section and the output-side section.

2. The computer-implemented method according to claim 1, wherein the training of the first machine-learning algorithm comprises:
providing a third training data set representing a result of the object detection having annotated objects in the individual images; and
training the first machine-learning algorithm by a first optimization algorithm that calculates an extreme value of a loss function for object detection.

3. The computer-implemented method according to claim 1, wherein the training of the second machine-learning algorithm comprises:
providing a fourth training data set representing a result of the object detection having annotated objects in the plurality of time series images; and
training the second machine-learning algorithm by a second optimization algorithm that calculates an extreme value of a loss function for object detection.

4. The computer-implemented method according to claim 1, wherein the second machine-learning algorithm receives the plurality of time series images of the second training data set in parallel.

5. The computer-implemented method according to claim 4, wherein the plurality of time series images of the second training data set are propagated in parallel by the input-side section of the second machine-learning algorithm.

6. The computer-implemented method according to claim 5, wherein the plurality of time series images of the second training data set propagated in parallel by the input-side section of the second machine-learning algorithm are received in parallel by a first of the additional layers inserted between the input-side section and the output-side section.

7. The computer-implemented method according to claim 6, wherein the first and/or a second of the additional layers inserted between the input-side section and the output-side section combines, and outputs at the output-side section of the second machine-learning algorithm the plurality of time series images of the second training data set.

8. The computer-implemented method according to claim 1, wherein a weighted sum is formed of the output data of the output-side section of the first machine-learning algorithm and the output data of the output-side section of the second machine-learning algorithm.

9. The computer-implemented method according to claim 8, wherein the output data of the output-side section of the second machine-learning algorithm are weighted more heavily than the output data of the output-side section of the first machine-learning algorithm.

10. The computer-implemented method according to claim 1, wherein the first machine-learning algorithm and/or the second machine-learning algorithm are composed of a recurrent neural network.

11. The computer-implemented method according to claim 1, wherein the plurality of time series images of the second training data set is composed of a sequence of four to five individual images over a time period of one to two seconds.

12. A computer-implemented method for object detection by a machine-learning algorithm, the method comprising:
providing) a first data set comprising a plurality of time series images based on sensor data of a vehicle environment;
applying a machine-learning algorithm trained according to claim 1 to the first data set comprising the plurality of time series images for object detection; and
outputting a second data set representing a result of the object detection, having objects or annotated objects in the plurality of time series images.

13. A system for providing a machine-learning algorithm for object detection, the system comprising:
a training computer configured to train a first machine-learning algorithm for object detection using a first training data set of individual images based on sensor data of a vehicle environment, the training computer being configured to train a second machine-learning algorithm for object detection using a second data set comprising a plurality of time series images; and
an input-side section and an output-side section of the second machine-learning algorithm have a predetermined number of layers derived from the trained first machine-learning algorithm,
wherein the input-side section of the second machine-learning algorithm has frozen weights, and
wherein the second machine-learning algorithm has a predetermined number of additional layers inserted between the input-side section and the output-side section.

14. A system for object detection by a machine-learning algorithm, the system comprising:
a data receiving device that is configured to receive a first data set comprising a plurality of time series images based on sensor data of a vehicle environment;
a computer configured to apply a machine-learning algorithm, trained according to claim 1, to the first data set comprising the plurality of time series images for object detection; and
an output configured to output a second data set representing a result of the object detection having annotated objects in the plurality of time series images.

15. A computer program with program code in order to carry out the method for object detection by a machine-learning algorithm according to claim 12 when the computer program is executed on a computer.
